(19) United States
(12) Patent Application Publication
(10) Pub. No.: US 2022/0162908 A1
(43) Pub. Date: May 26, 2022

(54) METHOD OF CONTROLLING ELECTRIC WINDOW COVERING

(71) Applicant: Nien Made Enterprise Co., Ltd., Taichung City (TW)

(72) Inventors: Chao-Hung Nien, Taichung City (TW); Jui-Pin Jao, Miaoli County (TW); Shih-Wei Hsu, Hsinchu County (TW); You-Yu Zhang, Hsinchu County (TW)

(21) Appl. No.: 17/319,053

(22) Filed: May 12, 2021

(30) Foreign Application Priority Data
Nov. 25, 2020 (TW) 109141329

(51) Int. Cl. E06B 9/68

(52) U.S. Cl. CPC E06B 9/68; E06B 2009/6845

(57) ABSTRACT

A method of controlling multiple electric window coverings includes the following steps: A. receive a check command, which is created from an electronic device operated by the user; B. compare battery levels of batteries of the electric window coverings to at least one power threshold; C. control the electric window coverings based on a comparison result obtained in the previous step, wherein, when the battery level of the battery of any one of the electric window coverings is greater than the power threshold, said electric window covering makes a first response; when the battery level of the battery of any one of the electric window coverings is less than the power threshold, said electric window covering makes a second response. Whereby, the user could learn the battery level of the battery of each of the electric window coverings from the response it makes.

### BACKGROUND OF THE DISCLOSURE

### 1. Field of the Disclosure

The present disclosure relates generally to an electric window covering, and more particularly to a method of controlling multiple electric window coverings.

### 2. Description of the Prior Art

The purpose of using window coverings is to cover the openings of buildings, whereby to provide concealment, heat insulation, shading, and other effects. A conventional window covering includes a slat assembly and a mechanical control device, and the user can manually operate the control device to bring the slat assembly open or close. With the advancement of technology, electric window coverings are also available on the market. Electric window coverings use motors as power sources to drive the slat assemblies open or close. Since the installation location of an electric window covering may not always have power wiring available for the motor, electric window coverings usually have built-in batteries to supply the power needed for operating the motors.

One drawback of conventional electric window coverings is that the user has no access to battery power status. The user would not notice low battery power and would not realize that the battery needs to be replaced or charged unless the battery power is so low that it is even unable to drive the motor to move the window covering, which is a quite inconvenient user experience. In addition, when there are multiple electric window coverings installed in the same space, the battery in each electric window covering would have a different power consumption rate, for not every electric window covering is used as frequently as others. Therefore, the user would not know how much power is left in the battery of each electric window covering, and would also not able to determine which electric window covering needs to have its battery replaced or charged first.

In order to improve the drawback mentioned above, some companies in the industry have made improvements to allow electric curtains to actively send out a low battery notification when the battery power falls below a specific set value. However, this improvement would also lead to some inconvenience issues. For example, when an electric window covering sends out a low battery notification, the user may not be in the vicinity of the electric window covering and miss the opportunity to receive the notification, and still not know that the electric window covering needs to be recharged. Or, even if the user is near the electric curtain, they may be unexpectedly disturbed by the low battery notification from the electric window covering. Furthermore, even if the user receives the low battery notification successfully, they may not be able to handle the charging matter immediately upon receiving the notification, and then forget to charge the electric window covering later due to the lack of continuous reminders. Therefore, battery notifications actively sent out by electric window coverings may not only disturb the user, but also affect the user's privacy and even cause safety concerns due to the unsatisfying reminder mechanism. In addition, if the user is not able to charge the battery in a timely manner, some types of batteries may even be worn out or even malfunction due to over-discharge.

In light of the above reasons, the conventional electric window coverings still have room for improvement.

### SUMMARY OF THE DISCLOSURE

One aspect of the present disclosure is to provide a method of controlling multiple electric window coverings, which would allow the user to actively initiate a power check process for any one of the electric window coverings and to monitor the power status of the battery thereof quickly.

The present disclosure provides a method for controlling multiple electric window coverings, each of which includes a covering material, a driving module, a battery, and a power detection module. The covering material is connected to the driving module to be driven to move thereby. The driving module includes a motor. The battery provides power to the motor, and the power detection module detects a battery level of the battery. The method includes the following steps: A. receive a check command, which is created by an operated electronic device; B. compare the battery level of the battery of each of the electric window coverings to at least one power threshold; and C. control the electric window coverings based on a comparison result obtained in the previous step in a manner that each of those electric window coverings having its battery level of the battery thereof higher than the at least one power threshold makes a first response, and each of those electric window coverings having its battery level of the battery thereof lower than the at least one power threshold makes a second response.

The effect of the disclosure is that after the user controls the electronic device so that the electric window coverings make different responses based on whether the battery level is above or below the power threshold, the user could recognize the battery power status of each electric window coverings by the responses. Therefore, by performing the above operation through the control of the user, the present disclosure would not only enhance the recognition capability to quickly find the window coverings that need to be charged, but also ensures the user's privacy and safety. In addition, the present disclosure could remind the user to charge the battery in a timely manner to avoid battery malfunction caused by over-discharge.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The present disclosure will be best understood by referring to the following detailed description of some illustrative embodiments in conjunction with the accompanying drawings, in which

FIG. 1 is a schematic view of a window covering control system which can be applied with the method of a first embodiment of the present disclosure;

FIG. 2 is a schematic view of the control device of the system mentioned above;

FIG. 3 is a flowchart of the method of controlling multiple electric window coverings of the first embodiment of the present disclosure;

FIG. 4 is a schematic view showing the content on the display of the system mentioned above;

FIG. 5 is a flowchart of the method of controlling multiple electric window coverings of a second embodiment of the present disclosure;

FIG. 6 is a flowchart of the method of controlling multiple electric window coverings of a third embodiment of the present disclosure;

FIG. 7 is a schematic view showing the content on the display of a system applied with any one of the first to the third embodiments mentioned above;

FIG. 8 is a schematic view showing the content on the display of a system applied with any one of the first to the third embodiments mentioned above;

FIG. 9 is a schematic view showing the content on the display of a system applied with any one of the first to the third embodiments mentioned above;

FIG. 10 is a schematic view showing the content on the display of a system applied with any one of the first to the third embodiments mentioned above;

FIG. 11 is a schematic view showing the content on the display of a system applied with any one of the first to the third embodiments mentioned above;

FIG. 12 is a schematic view showing the content on the display of a system applied with any one of the first to the third embodiments mentioned above;

FIG. 13 is a schematic view showing the content on the display of a system applied with any one of the first to the third embodiments mentioned above;

FIG. 14 is a flowchart of positioning an electric window covering through any one of the methods of the first to the third embodiments mentioned above;

FIG. 15 is a flowchart for a compulsory power check through anyone of the methods of the first to the third embodiments mentioned above;

FIG. 16 is a flowchart showing any one of the methods of the first to the third embodiments mentioned above when the power is lower than a first lower limit and/or a second lower limit; and

FIG. 17 is a schematic view of a control device of a system applied with an embodiment of the present disclosure.

### DETAILED DESCRIPTION

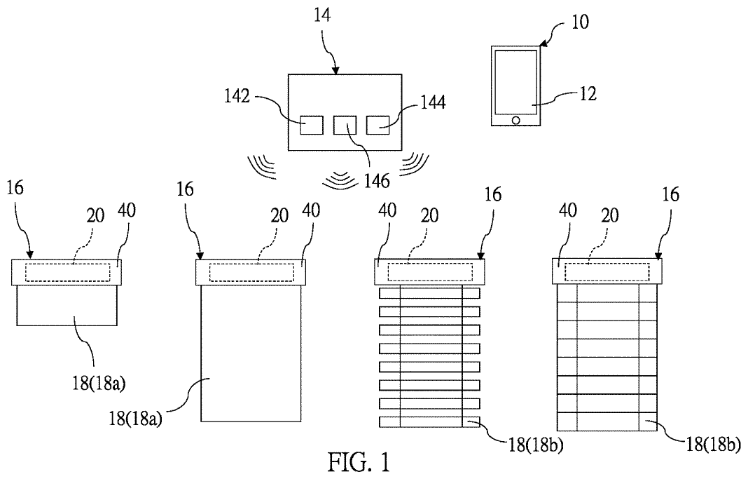

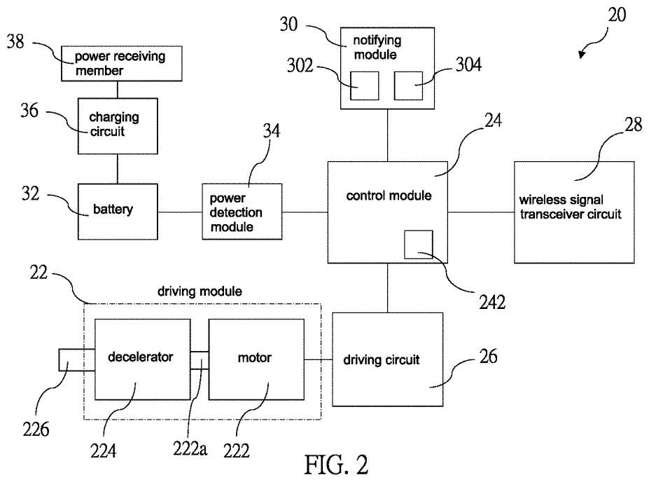

A window covering control system applied with a method of controlling multiple electric window coverings of a first embodiment of the present disclosure is shown in FIG. 1 and FIG. 2, wherein the window covering control system includes an electronic device 10, a relay device 14, and a plurality of electric window coverings 16.

The electronic device 10 is a smartphone as an example, but this is not a limitation of the present disclosure; in other embodiments, the electronic device 10 could also be a tablet computer, a laptop computer, or a personal computer. The electronic device 10 is adapted to be used to run an application which controls the electric window coverings 16, and has a display 12 such as a touch screen. The display 12 shows the user interface of the application, through which the user could operate to send out commands wirelessly.

The relay device 14 communicates with the electronic device 10 wirelessly. In the current embodiment, the relay device 14 includes, but is not limited to, a first communication module 142 and a second communication module 144. The relay device 14 communicates with the electronic device 10 wirelessly through the first communication module 142, wherein the first communication module 142 could use Wi-Fi signals to communicate with the electronic device 10, but this is not a limitation of the present disclosure; in other embodiments, wireless signal communication suck as Bluetooth, ZigBee, or any protocols alike could also be used. The relay device 14 communicates with each of the electric window coverings 16 through the second communication module 144, wherein the second communication module 144 is used to send out wireless signals, which could be radio frequency (RF) signals for example, of which common frequencies may be 315 MHz, 433 MHz, or 2.4 GHz; however, the type and frequencies of the signals are not limitations of the present disclosure, and wireless signals of Bluetooth, ZigBee, or other kinds of protocols could also be used in other embodiments. The relay device 14 further includes a memory 146, which is used for saving data. In the current embodiment, there are two communication modules 142, 144 respectively used between the electronic device 10 and the relay device 14 and between the electric window covering 16 and the relay device 14 for transmitting and receiving signals, wherein the communication modules 142, 144 could use the same or different protocols in consideration of their design requirements. For instance, the electronic device 10 and the relay device 14 could use wireless local area network (LAN) communication protocol for signal transmissions therebetween, while the electric window coverings 16 and the relay device 14 could use communication protocols such as wireless personal area network for signal transmissions therebetween. In another embodiment, the electronic device 10, the relay device 14, and the electric window coverings 16 could also use two communication modules 142, 144 which both follow the same communication protocol for signal transmissions. In other feasible embodiments, the relay device 14 could be only provided with one single communication module (not shown), which could communicate with the electronic device 10 and each of the electric window coverings 16 in a wireless manner.

Each of the electric window covering 16 includes a covering material 18 and a control device 20, wherein, in the current embodiment, the covering material 18 of each of the electric window coverings 16 is either a shading piece 18a as in a roller shade or a slat assembly 18b as in a blind, but these are merely examples, not limitations of the present disclosure; in other embodiments, other types of covering material 18 such as those in shutters, cellular shades, sheer shade, etc., could also be selected. In other words, any electric window coverings having a battery and controllable through an electronic device should be considered inside the scope of the present disclosure. The control device 20 is provided in an outer casing, which is a head rail 40 as an example. The control device 20 includes a driving module 22, a control module 24, a driving circuit 26, a wireless signal transceiver circuit 28, a notifying module 30, a battery 32, and a power detection module 34. The driving module 22 is connected to the covering material 18, and is used to drive the covering material 18 to move, whereby to change the extent of opening of the covering material 18. The driving module 22 includes a motor 222, a decelerator 224, and an output shaft 226. The decelerator 224 is coupled between a rotating shaft 222a of the motor 222 and the output shaft 226, and the output shaft 226 is coupled to the covering material 18. The control module 24 could further include a microcontroller. The control module 24 is electrically connected to the motor 222 through the driving circuit 26, so that control signals outputted by the control module 24 can be converted into driving commands by the driving circuit 26, wherein the driving commands are able to make the motor 222 rotate. The control module 24 includes a memory 242, and the memory 242 keeps a unique identifier. The unique identifier of each of the electric window coverings 16 is different. The control module 24 is electrically connected to the wireless signal transceiver circuit 28, and the control module 24 communicates with the second communication module 144 of the relay device 14 through the wireless signal transceiver circuit 28.

The notifying module 30 is electrically connected to the control module 24, and the notifying module 30 includes at least a light member 302 and at least a sound member 304, wherein the light member 302 can be a LED as an example, and the sound member 304 can be a buzzer or speaker, for example. The control module 24 controls the notifying module 30 to make the light member 302 emit light and the sound member 304 emit sound. The battery 32 provides power to power-required components, including the motor 222, the control module 24, the driving circuit 26, the wireless signal transceiver circuit 28, the notifying module 30, etc. The power detection module 34 electrically connects the battery 32 and the control module 24, wherein the power detection module 34 detects a battery level of the battery 32, and transmits related information to the control module 24.

In the current embodiment, the battery 32 is a rechargeable battery, and the control device 20 further includes a charging circuit 36 and a power receiving member 38, wherein the charging circuit 36 electrically connects the power receiving member 38 and the battery 32. The power receiving member 38 could be a connector adapted to be connected by a connector of an external charging power source (not shown). The charging circuit 36 converts the power of the external charging power source into a charging power, which can be provided to the battery 32. In another embodiment, the power receiving member 38 could be a wireless charging coil that receives power from an external wireless charging power source in a wireless manner, and the received power could be then converted by the charging circuit 36 into the charging power which is going to be provided to the battery 32. The battery 32 is used to provide power to each power-required component in the electric window covering 16. To simplify the drawings for better illustration, the connections between the battery and each of the components of the electric window covering 16 are not all shown in FIG. 2.

In the above embodiments and figures, the control device 20 is configured to situate in the head rail 40. In other embodiments, one or more components of the control device 20 may be respectively configured to situate in the head rail 40, the bottom rail (not shown in the figures) and/or the middle rail (if there is one). For example, the battery 32, the charging circuit 36 and/or the power receiving member 38 may be configured in the bottom rail for the user to easily charge the battery 32. In another embodiment, the battery 32 may be configured to be detachably received in the bottom rail, and the charging circuit 36 and/or the power receiving member 38 may be integrated with the battery 32 or integrated in an external charger (not shown). The battery 32 in the bottom rail may be easily reached, changed, and charged.

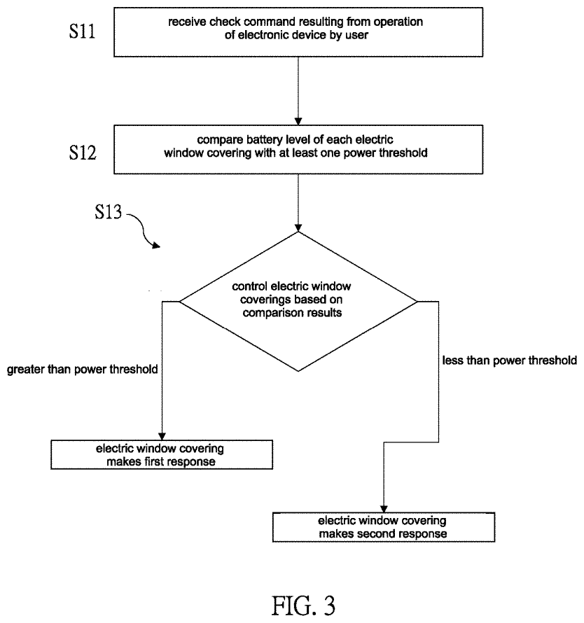

With the aforementioned structure, the control method shown in FIG. 3 can be performed. The control method includes the following steps:

Step S11: receive a check command, wherein the check command is resulting from the operation of the electronic device 10 by the user.

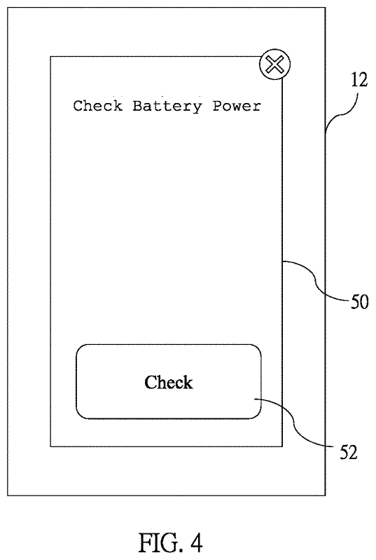

As shown in FIG. 4, in the current embodiment, the electronic device 10 runs the application and shows a “Check Battery Power” message on the display 12 through the user interface 50. By clicking a button 52 saying “Check” in FIG. 4, the electronic device 10 is operated to create the check command, which is then transmitted to the relay device 14 wirelessly. After the relay device 14 receives the check command, the relay device 14 sends out a control command to the electric window coverings 16 according to the check command. In the current embodiment, the relay device 14 sends out the control command via broadcast, demanding all the window coverings to check their battery level. However, said scenario is not a limitation of the present disclosure; in practice, the relay device 14 could also perform the command sending operation only to a single one of or a group of the electric window coverings 16, i.e., the relay device 14 could only require one or more specific window coverings to check the battery level.

Step S12: compare the battery level of the battery 32 of each of the electric window coverings 16 with at least one power threshold.

In the current embodiment, the memory 242 of the control module 24 of each of the electric window coverings 16 holds the at least one power threshold, which could be predetermined as a default value or defined by the user. Moreover, the power threshold could be set as 30%, 20%, or 10% of the full capacity of the battery level of the battery 32; however, this is not a limitation of the present disclosure. In practice, the power threshold could be set as any percentage between 0% and 100%, or could be set based on a predetermined voltage and/or current value. Furthermore, in the current embodiment, the power thresholds stored in the control modules 24 are the same, but this is also not a limitation of the present disclosure; it would also be possible to have different power thresholds set and stored in the control modules 24. After the wireless signal transceiver circuit 28 of each of the electric window coverings 16 receives the control command, each of the control modules 24 compares the battery level of the associated battery 32 detected by the associated power detection module 34 with the power threshold stored in the associated memory 242.

The power threshold of each of the electric window coverings 16 could be stored into the memory 242 in advance, i.e., prior to Step S12. For example, the power threshold could be stored in the memory 242 during manufacturing one of the electric window coverings in the factory. Alternatively, the power threshold could be transmitted to the control module 24 by the electronic device 10 through the relay device 14 at a random or a specific time point prior to Step S12, whereby to be stored in the control module 24.

Besides, in other embodiments, the check command sent out from the electronic device 10 to the relay device 14 in Step 11 could include a power threshold, and the relay device 14 could store the power threshold in the memory 146. When the relay device 14 sends out the control command via broadcast afterward, the control command would contain the power threshold sent from the electronic device 10. At this time in Step S12, each of the control modules 24 compares the battery level of the associated battery 32 with the power threshold contained in the received control command.

Step S13: control the electric window coverings 16 based on comparison results obtained in the previous step, wherein, each of the electric window coverings 16 which the battery level of the battery 32 thereof is greater than the at least one power threshold makes a first response, while each of the electric window coverings 16 which the battery level of the battery 32 thereof is less than the at least one power threshold makes a second response.

In the current embodiment, for each of the electric window coverings 16 which the battery level of the battery 32 thereof is greater than or equal to the power threshold, the control module 24 thereof controls the associated electric window covering 16 to make the first response; for each of the electric window coverings 16 which the battery level of the battery 32 thereof is less than the power threshold, the control module 24 thereof makes the associated electric window covering 16 to make the second response. For each of the electric window coverings 16, the first response and the second response mentioned above could be made by opening the covering material 18 thereof to different extents, by creating different notifying states through the notifying module 30, or by both ways mentioned herein. The details are explained in the following paragraphs:

A. Opening the Covering Material 18 to Different Extents as an Example:

For each of the electric window coverings 16 going to make the first response, the control module 24 thereof controls the associated driving module 22 through the associated driving circuit 26 to move the associated covering material 18 to a first position, and such operation is referred to as the first response; for each of the electric window coverings 16 going to make the second response, the control module 24 thereof controls the associated driving module 22 through the associated driving circuit 26 to move the associated covering material 18 to a second position, and such operation is referred to as the second response. The extent that each of the covering materials 18 is opened when moved to the first position is different from the extent that it is opened when moved to the second position. With such design, by simply checking the positions of the covering material 18 of the electric window coverings 16 and how open they are, the user could directly and quickly tell if there is any electric window covering 16 has a battery level lower than the threshold and therefore needs to be charged. In another embodiment, the electric window coverings 16 could change the extent of opening of the covering materials 18 to notify the user only when making the first response or only when making the second response; in other words, the covering materials 18 may not move at all while the electric window coverings 16 are making one of the first and second responses.

Preferably, each of the covering materials 18 is more opened when moved to the first position than it is when moved to the second position. Take roller shades and window blinds as an example. To make any of the covering materials 18 to travel the same distance upward or downward, the associated motor would need to provide more effecting force for the upward movement, and therefore the upward movement consumes more electric power than the downward movement does. Due to this reason, it would be reasonable to stipulate any of the covering materials 18 to be more open when at the first position than it is when at the second position. More specifically, for any one of the electric window coverings 16 of which the battery 32 has a battery level lower than the threshold, the covering material 18 thereof would be moved from its current position to the second position either by extending downward or by retracting upward over a short distance, and therefore the battery 32 would not consume too much power during the movement. In addition, given the covering material 18 is less opened when at the second position, even if the battery level of the battery 32 is insufficient to drive the motor 222, and therefore unable to move the covering material 18 to the second position, the covering material 18 would remain covering a relatively large area, whereby to still ensure privacy. For example, the first position could be the position where the covering material 18 is fully opened, and the second position could be another position where the covering material 18 is fully lowered or partially opened.

In an embodiment, how much a covering material 18 is opened when it is located at the first position and when it is located at the second position is proportional to the battery level of the associated battery 32. In other words, for each of the electric window coverings 16, the control module 24 thereof controls the covering material 18 thereof to change between a fully opened (100% opened) state and a fully closed (0% opened) state base on the percentage of the detected battery level. For instance, in a circumstance that the power threshold is set as 50%, if the battery level of the battery 32 is detected to be 60%, the control module 24 controls the driving module 22 to drive the covering material 18, moving the covering material 18 to a position where it is 60% opened; the position at this time is the first position of the covering material 18. On the other hand, if the battery level of the battery 32 is detected to be 20%, the control module 24 controls the driving module 22 to drive the covering material 18, moving the covering material 18 to another position where it is 20% opened; the current position is the second position of the covering material 18.

B. Creating Different Notifying States Through the Notifying Module 30 as an Example:

For each of the electric window coverings 16 going to make the first response, the control module 24 thereof controls the associated notifying module 30 to create a first notifying state, which could be light or sound, or a combination of both; for each of the electric window coverings 16 going to make the second response, the control module 24 thereof controls the associated notifying module 30 to create a second notifying state, which is different from the first notifying state. Similarly, the second notifying state could be light or sound, or a combination of both.

For example, the first notifying state is the light member 302 emitting light of a first form, and the second notifying state is the light member 302 emitting light of a second form, wherein the light of the first form and the light of the second form could be distinguishable by different blinking frequencies and/or colors. In an embodiment, the light of the first form is steady, while the light of the second form blinks; in addition, the light of the first form could be of a first color, and the light of the second form could be of a second color. Whereby, the user could learn about the battery level of the battery 32 of any one of the electric window coverings 16 through the form of the light emitted from the light member 302. In another embodiment, the electric window coverings 16 could create light to remind the user only when making the first response or only when making the second response.

For another example, the first notifying state is the sound member 304 making a sound of a first form, and the second notifying state is the sound member 304 making a sound of a second form, wherein the sound of the first form and the sound of the second form could be distinguishable by different lengths and/or frequencies. In an embodiment, the first form is a long-lasting sound, while the second form is a periodic beeping. Whereby, the user could learn about the battery level of the battery 32 of any one of the electric window coverings 16 through the form of the sound made by the sound member 304. In another embodiment, the electric window coverings 16 could make a sound to remind the user only when making the first response or only when making the second response.

With the control method mentioned above, the user could learn about the battery level of the battery 32 through the first response or the second response made by each of the electric window coverings 16, and they could, if necessary, connect an external charging power source to the power receiving member 38 of any one of the electric window coverings 16 making the second response, whereby to charge the battery 32 of any one of electric window coverings 16 having a lower battery level first. It is worth mentioning that the electric window coverings 16 make responses only when the user actively operates the electronic device 10, and therefore the user is surely well prepared and would not be unexpectedly disturbed by the responses made by any one of the electric window coverings 16; furthermore, the user's privacy would not be violated unknowingly. In addition, since the responses of the electric window coverings 16 only happen after the user actively operates the electronic device 10, the user would notice the responses made by the electric window coverings 16 more attentively, which would help the user to immediately distinguish the first response from the second response, whereby the user could properly and timely charge the electric window coverings 16 having lower battery levels. It needs to be specified that, in the above-mentioned control method, the user does not need to exactly know the actual battery level of the batteries 32 of the electric window coverings 16; on the contrary, by simply observing the first response or the second response made by each of the electric window coverings 16, it could be clearly known which, if any, electric window coverings 16 would have to be charged.

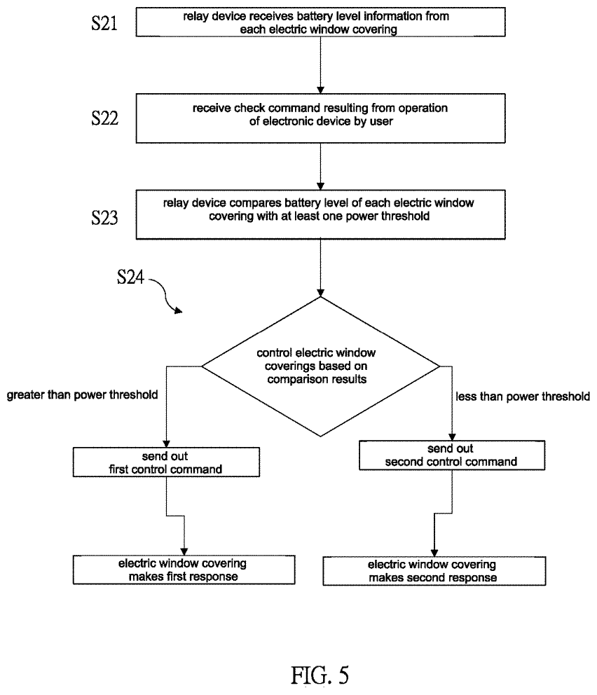

A method of controlling multiple electric window coverings of a second embodiment of the present disclosure is shown in FIG. 5, which has roughly the same steps as the first embodiment, except that:

Step S21: the relay device 14 receives a battery level information from each of the electric window coverings 16, wherein the battery level information is periodically or aperiodically transmitted to the relay device 14 to be saved in the memory 146 thereof by the control module 24 of each of the electric window coverings 16 through the associated wireless signal transceiver circuit 28, and the battery level information regards the battery level of the associated battery 32 detected by the associated power detection module 34. Preferably, while transmitting the battery level, the unique identifier of the control module 24 of each of the electric window coverings 16 would be transmitted as well, whereby to form the battery level information. The relay device 14 saves the received battery level and unique identifier in the memory 146. In addition, the at least one power threshold is stored in the memory 146 of the relay device 14. In an embodiment, the at least one power threshold includes multiple power thresholds, each of which corresponds to one of the electric window coverings 16, respectively.

Step S22: receive a check command, which is created by the electronic device 10 after the user who operates the electronic device clicks the “Check” button 52, and is sent out to the relay device 14 in a wireless manner.

Step S23: after the relay device 14 receives the check command sent from the electronic device 10, the relay device 14 compares the battery level of the battery 32 of each of the electric window coverings 16 with the at least one power threshold. In the current embodiment, the relay device 14 compares the battery level of the battery 32 of each of the electric window coverings 16 stored in the memory 146 with the at least one power threshold which is also stored in the memory 146. In the situation that there is more than one power threshold, the relay device 14 would compare the battery level of the battery 32 of each of the electric window coverings 16 with the corresponding power threshold, respectively.

In other embodiments, the at least one power threshold could be stored into the memory 146 in advance before taking Step S23. For example, the at least one power threshold could be stored in the memory 146 during the manufacturing process of the electric window coverings in the factory; or, the electronic device 10 could transmit the at least one power threshold to the relay device 14 to be stored in the memory 146 at a specific or an arbitrary time point in prior to Step S23.

Besides, in other embodiments, the check command which is transmitted from the electronic device 10 to the relay device 14 in Step S22 could contain at least one power threshold, whereby the relay device 14 could save the at least one power threshold in the memory 146.

Step S24: the relay device 14 sends out a first control command at least to each of the electric window coverings 16 which the battery level of the battery 32 thereof is greater than the at least one power threshold, wherein, for each of the electric window coverings 16 which the battery level of the battery 32 thereof is greater than the at least one power threshold, after the wireless signal transceiver circuit 28 thereof receives the first control command, the control module 24 thereof makes the electric window covering 16 it belongs to make the first response; the relay device 14 sends out a second control command at least to each of the electric window coverings 16 which the battery level of the battery 32 thereof is less than the at least one power threshold, wherein, for each of the electric window coverings 16 which the battery level of the battery 32 thereof is less than the at least one power threshold, after the wireless signal transceiver circuit 28 thereof receives the second control command, the control module 24 thereof makes the electric window covering 16 it belongs to make the second response. In another embodiment, the relay device 14 could be set up in a manner that it sends out a corresponding control command only to each of the electric window coverings 16 which has a battery level greater than the at least one power threshold, or only to each of the electric window coverings 16 which has a battery level less than the at least one power threshold.

It should be added that, regarding how the relay device 14 sends the control commands, it could be done at least by broadcasting the control commands to all of the electric window coverings 16, or it could be done by sending specific control commands to one or a group of electric window coverings 16; however, the practical implementations are not limited to the examples provided herein. In the current embodiment, the relay device 14 sends out the first control command and the second control command to the electric window coverings 16 via broadcast, wherein the first control command and the second control command respectively contains a first identifier and a second identifier. The first identifier is a set containing the unique identifiers of the electric window coverings 16 that the first control command intends to control, and the second identifier is a set containing the unique identifiers of the electric window coverings 16 that the second control command intends to control. After the wireless signal transceiver circuit 28 of each of the electric window coverings 16 receives the first control command and the second control command, the control module 24 of the control device 20 of each of the electric window coverings 16 compares the unique identifier saved in the memory 242 thereof with the first identifier contained in the first control command and the second identifier contained in the second control command, and controls the associated electric window covering 16 to correspondingly make the first response or the second response according to the comparison result. In a case that the battery levels of the batteries 32 of all of the electric window coverings 16 are greater than the at least one power threshold, the relay device 14 could only send out the first control command to every one of the electric window coverings 16; meanwhile, the first identifier contained in the first control command is a set containing the unique identifiers of all of the electric window coverings 16. Similarly, in another case that the battery levels of the batteries 32 of all of the electric window coverings 16 are less than the at least one power threshold, the relay device 14 could only send out the second control command to every one of the electric window coverings 16; meanwhile, the second identifier contained in the second control command is a set containing the unique identifiers of all of the electric window coverings 16.

In other feasible embodiments, the relay device 14 could send out specific control command to a specific one or a specific group of the electric window coverings 16. For example, after the relay device 14 compares the battery levels of the batteries 32 of the electric window coverings 16 with the at least one power threshold, the relay device 14 only sends out the first control command to one or a group of the electric window coverings 16 which the battery levels of the batteries 32 thereof are greater than the at least one power threshold, and only sends out the second control command to the rest of the electric window coverings 16. After that, each of the electric window coverings 16 correspondingly makes the first response or the second response according to the first control command or the second control command it receives. However, no matter which one of the previously mentioned ways the relay device 14 takes, the effect of controlling the electric window coverings 16 could all be achieved. In addition, the first response and the second response are the same as mentioned in the first embodiment, and therefore we are not going to describe them again herein.

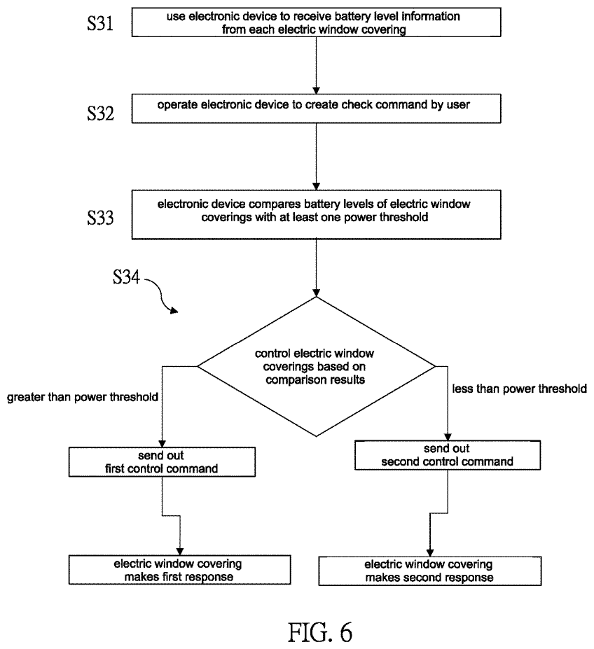

A method of controlling multiple electric window coverings of a third embodiment of the present disclosure is shown in FIG. 6, which includes basically the same steps as the second embodiment, except that:

Step S31: the electronic device 10 receives a battery level information from each of the electric window coverings 16, wherein the battery level information is periodically transmitted to the electronic device 10 via the relay device 14 by the control module 24 of each of the electric window coverings 16 through the associated wireless signal transceiver circuit 28, and the battery level information regards the battery level of the associated battery 32 detected by the associated power detection module 34. Preferably, while transmitting the battery level, the unique identifier of the control module 24 of each of the electric window coverings 16 would be transmitted as well, whereby to form the battery level information. The electronic device 10 saves the received battery level and unique identifier in a memory thereof (not shown). In addition, the at least one power threshold is stored in the memory of the electronic device 10. The power threshold could be a predetermined default value, or could be defined by the user. In an embodiment, the at least one power threshold includes multiple power thresholds, each of which corresponds to one of the electric window coverings 16, respectively.

Step S32: create a check command through the electronic device 10 after the user who operates the electronic device 10 clicks the “Check” button 52.

Step S33: after the electronic device 10 creates the check command, the electronic device 10 starts to compare the battery levels of the batteries 32 of the electric window coverings 16 stored in the memory thereof with the at least one power threshold. If there is more than one power threshold, the electronic device 10 would compare the battery level of the battery 32 of each of the electric window coverings 16 with the corresponding power threshold, respectively.

Step S34: the electronic device 10 sends out a first control command at least to each of the electric window coverings 16 which the battery level of the battery 32 thereof is greater than the at least one power threshold via the relay device 14, wherein, for each of the electric window coverings 16 which the battery level of the battery 32 thereof is greater than the at least one power threshold, after the wireless signal transceiver circuit 28 thereof receives the first control command, the control module 24 thereof makes the electric window covering 16 it belongs to make the first response; the electronic device 10 sends out a second control command at least to each of the electric window coverings 16 which the battery level of the battery 32 thereof is less than the at least one power threshold via the relay device 14, wherein, for each of the electric window coverings 16 which the battery level of the battery 32 thereof is less than the at least one power threshold, after the wireless signal transceiver circuit 28 thereof receives the second control command, the control module 24 thereof makes the electric window covering 16 it belongs to make the second response.

Wherein, the relay device 14 relays the first control command and the second control command in the same ways as to how the relay device 14 sends out the commands in the second embodiment. In other words, it could be done at least by broadcasting the control commands to all of the electric window coverings 16, or it could be done by sending specific control commands to one or a group of electric window coverings 16; however, the practical implementations are not limited to the examples provided herein. In the current embodiment, the relay device 14 sends out the first control command and the second control command to the electric window coverings 16 via broadcast, wherein the first control command and the second control command respectively contains a first identifier and a second identifier. The first identifier is a set containing the unique identifiers of the electric window coverings 16 that the first control command intends to control, and the second identifier is a set containing the unique identifiers of the electric window coverings 16 that the second control command intends to control. After the wireless signal transceiver circuit 28 of each of the electric window coverings 16 receives the first control command and the second control command, the control module 24 of the control device 20 of each of the electric window coverings 16 compares the unique identifier thereof with the first identifier and the second identifier, and controls the associated electric window covering 16 to correspondingly make the first response or the second response according to the comparison result.

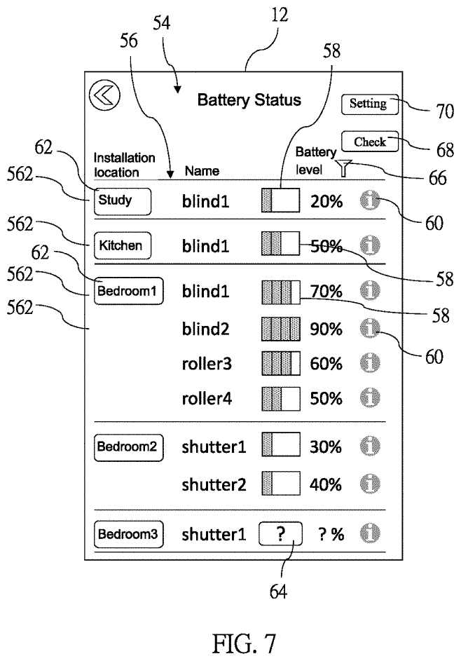

Moreover, in the embodiments above, the application that the electronic device 10 of the present disclosure uses to control the electric window coverings 16 could also show a user interface 54 of “Battery Status” on the display 12 during its operation, as shown in FIG. 7. The user interface 54 of “Battery Status” shows a list 56 of the electric window coverings 16, and each item 562 in the list 56 respectively corresponds to one of the electric window coverings 16, and the mapping could be done, for example, based on the unique identifier of each of the electric window coverings 16. Furthermore, each item 562 in the list 56 records an installation location, a name, the battery level of the battery, a battery level icon 58, and a positioning icon 60 of each of the electric window coverings 16. Understandably, the user interface 54 of “Battery Status” could, by the design of the application, show the status between any steps of any one of the embodiments mentioned above, or be a start screen of each of the embodiments. It has to be emphasized that all the icons shown in the user interface 54 are merely an implementation, and their positions, shapes, and spatial arrangements between each other are not limitations of the present disclosure.

In the current embodiment, the installation locations of the electric window coverings 16 are represented by buttons 62, wherein the electric window coverings 16 installed at the same installation location are represented by a single one of the buttons 62. The battery level icon 58 of each of the items 562 represents the battery level of the battery 32 of the corresponding electric window covering 16. The higher the battery level of the battery 32 is, the more power grids are shown in the battery level icon 58. The positioning icon 60 of each of the items 562 is a button, which allows the user to click for checking the physical location of the corresponding electric window covering 16 in an actual environment; the function of the positioning icon 60 will be described later. The control module 24 of each of the electric window coverings 16 periodically transmits the battery level of the associated battery 32 detected by the associated power detection module 34, along with the associated unique identifier, to the relay device 14 through the associated wireless signal transceiver circuit 28, whereby to store the transmitted battery level and unique identifier in the memory 146 of the relay device 14. After that, when the electronic device 10 communicates with the relay device 14, the relay device 14 would further transmit the battery level of the battery 32 and the unique identifier which are stored in its memory 146 to the electronic device 10. Eventually, the electronic device 10 shows the battery level of each of the electric window coverings 16 on the list 56. Besides, in addition to the implementation described herein, i.e., the control module 24 of each of the electric window coverings 16 periodically and actively transmits the information regarding the battery level of the associated battery 32 and the associated unique identifier to the relay device 14, the flow in other feasible embodiments could also be designed in a manner that the relay device 14 periodically or aperiodically sends commands to the electric window coverings 16 to actively request the electric window coverings 16 to check the battery levels of the batteries 32, and to transmit the detected battery levels and the unique identifiers to the relay device 14 to get stored in the memory 146 thereof. In another embodiment, the battery level icon 58 could also be shown in image or text forms specifying whether the referred battery needs to be charged or not.

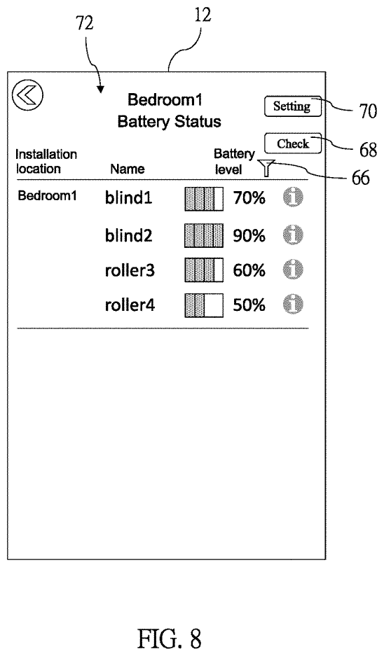

After clicking one of the buttons 62 of the installation locations, say, the button 62 of “Bedroom 1”, the display 12 would then display the user interface 72 titling “Bedroom 1/Battery Status”, which shows the status of the batteries in this “bedroom 1”, as shown in FIG. 8.

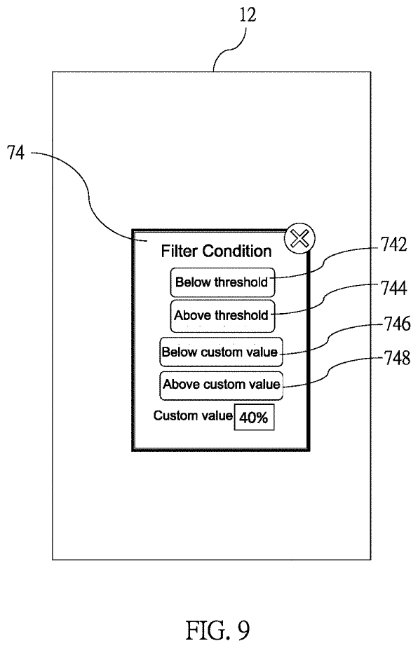

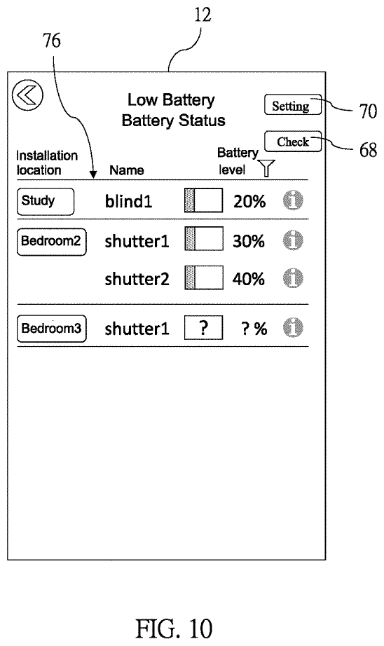

In the user interfaces 54, 72 respectively shown in FIG. 7 and FIG. 8, there are also a button 66 representing “filtering”, a button 68 saying “Check”, and a button 70 saying “Setting”. To further filter the electric window coverings in the user interfaces 54, 72 in FIG. 7 and FIG. 8 based on the differences between the battery levels, the user should click the “filtering” button 66 first, which evokes a pop-up window 74 titling “Filter Condition” on the display 12, as shown in FIG. 9. The pop-up window 74 has four buttons 742, 744, 746, 748, which allows the user to decide what filter condition to select. For example, by clicking the button 742 saying “below threshold”, the electric window coverings 16 with a battery level lower than the power threshold could be filtered out and listed, as shown in FIG. 10. Of course, the user could also enter a customized value through the pop-up window 74 in FIG. 9, which could then be used as a filter condition.

In addition, in the user interfaces shown in FIG. 7, FIG. 8 and FIG. 10, after the user clicks the “Check” button 68, each step of methods similar to each of the first, the second, and the third embodiments could be taken to perform the battery level checking operation, wherein, the “Check” button 68 in FIG. 7 is designed to control any one of the electric window coverings 16 shown in the list 56, and the “Check” button 68 is designed to control any one of the electric window coverings installed at the same installation location (“bedroom 1” in this case). The “Check” button 68 in FIG. 10 is designed to control any one of the electric window coverings 16 shown in a list 76, whereby to perform the battery level checking operation, and to command the electric window coverings 16 to make responses or notifications correspondingly.

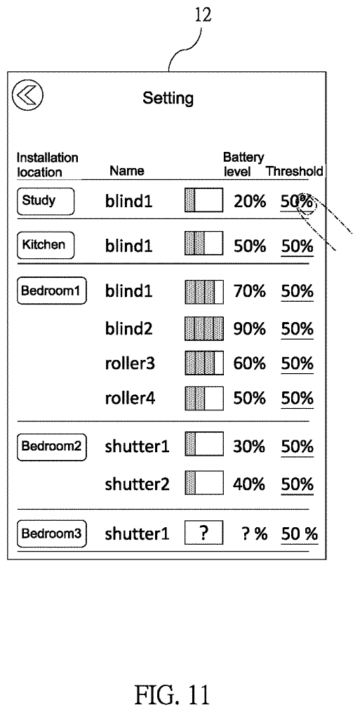

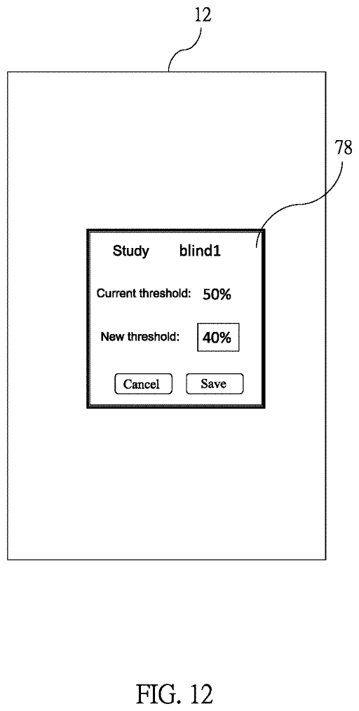

In addition, as mentioned in the embodiments described above, the user could also customize the power threshold to meet their request. By clicking the “Setting” button 70 in FIG. 7, the user interface on the display would show the current power thresholds of the electric window coverings 16, as shown in FIG. 11. After clicking on the number shown in the power threshold field of any one of the electric window coverings 16 (say, blind 1 in the study), the display 12 provides a pop-up window 78 shown in FIG. 12 for the user to set up the power threshold. With such design, the user could change the power thresholds corresponding to the electric window coverings 16 when necessary.

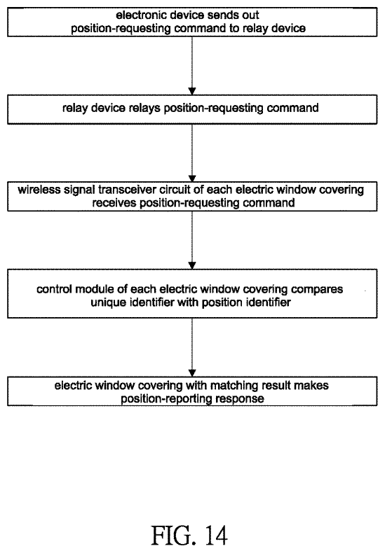

Please refer to FIG. 7, FIG. 8, and FIG. 10 again. In addition to the control methods mentioned above, in other feasible embodiments, if the user wants to know the physical location of any one of the electric window coverings 16 corresponding to one of the electric window coverings contained in the list of the user interface at any given time point (e.g., to know where the physical location of “blind2” in the actual environment of the “Bedroom 1” is), all the user needs to do is to click the positioning icon 60 corresponding to the chosen electric window covering (in our example, “blind2” of “Bedroom 1”), the following steps shown in FIG. 14 would be then taken. Specifically, the electronic device 10 would send out a position-requesting command to the relay device 14, wherein the position-requesting command contains a position identifier, which is the unique identifier of the electric window covering 16 that corresponds to the item in the list associated with the clicked positioning icon 60; in our example, the position identifier is the unique identifier of “blind2” in “Bedroom 1”. The relay device 14 would then relay the position-requesting command. After the wireless signal transceiver circuit 28 of each of the electric window coverings 16 receives the position-requesting command, the control module 24 of each of the electric window coverings 16 would compare the associated unique identifier with the position identifier. Each of the electric window coverings 16 with a matching result would make a position-reporting response, which means, it is “blind2” in “Bedroom 1” that makes the position-reporting response in our example. The position-reporting response could be implemented using the control module 24 to control the driving module 22, whereby to drive the covering material 18 to move in a predetermined manner. For example, the covering material 18 could move back and forth several times. The position-reporting response could also be implemented as using the control module 24 to control the notifying module 30 for creating a third notifying state, which is different from the first and the second notifying states, and could be, for example, the at least one light member omitting light of a third form, or the at least one sound member making a sound of a third form.

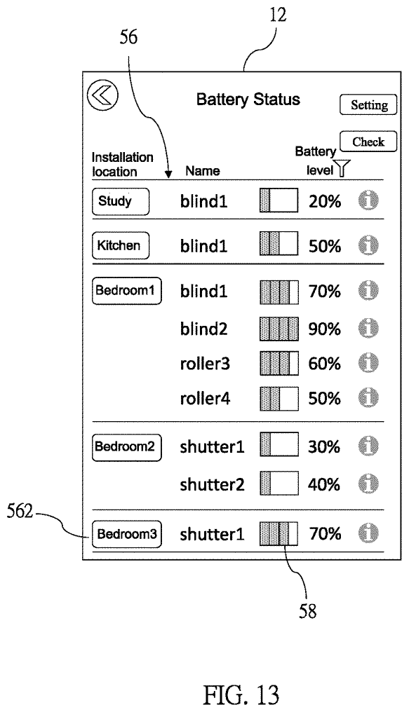

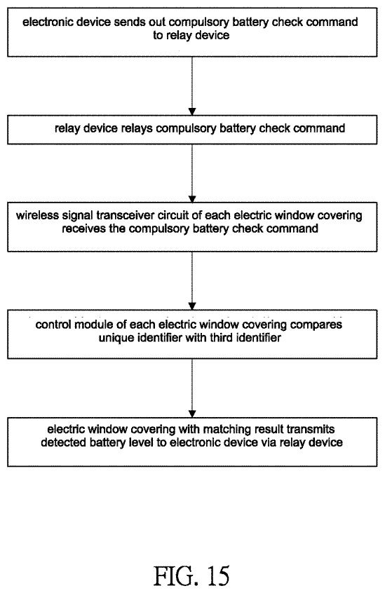

As shown in FIG. 7, it has to be clarified that, although the control module 24 of each of the electric window coverings 16 would periodically transmit the battery level of the associated battery 32 and the associated unique identifier to the relay device 14 and the electronic device 10, in some situations, the transmission of the battery levels of the batteries 32 and the unique identifiers of the electric window coverings 16 may partially lose and therefore would not be completely delivered to the electronic device 10. The way how the user interface 54 of the electronic device 10 deals with missing information is exemplarily shown in FIG. 7, wherein the electric window covering 16 which is labeled as “shutter1” and installed in “Bedroom 3” has its battery level expressed as “?%”, while the battery level icon is shown as the button 64 saying “?”, wherein the button 64 is clickable by the user. At this time, if the user wants to actively check the battery level of the electric window covering that has the battery level information missing, the user only needs to click the corresponding button 64 saying “?”, and the steps shown in FIG. 15 could then be taken, wherein the electronic device 10 would send out a compulsory battery check command to the relay device 14. The compulsory battery check command contains a third identifier, which is the unique identifier of the electric window covering 16 that corresponds to the list item associated with the clicked button 64. In the example shown in FIG. 7, the third identifier is the unique identifier of “shutter1” of “Bedroom 3”. The relay device 14 would then relay the compulsory battery check command. After the wireless signal transceiver circuit 28 of each of the electric window coverings 16 receives the compulsory battery check command, the control module 24 of each of the electric window coverings 16 would compare the associated unique identifier with the third identifier. The electric window covering with a matching result would then transmit the battery level of the battery 32 thereof detected by the power detection module 34 thereof to the electronic device 10 through the wireless signal transceiver circuit 28 thereof and via the relay device 14. The unique identifier of this electric window covering would be transmitted as well so that the electronic device 10 could accordingly update the battery level and the battery level icon 58 of the corresponding item 562 in the list 56. For example, the electric window covering 16 “shutter1” of “Bedroom 3” shown in FIG. 13 results from the update. It has to be emphasized that, in addition to the unique identifier of one single window covering as mentioned above (e.g., the unique identifier of “shutter1” of “Bedroom 3”), the third identifier in other embodiments could also be a set consisting of the unique identifiers of all of the electric window coverings that have their battery level information missing. With such design, the user could demand all window coverings with no battery level information to report their battery level information back to the electronic device 10 by simply clicking the button 64 once.

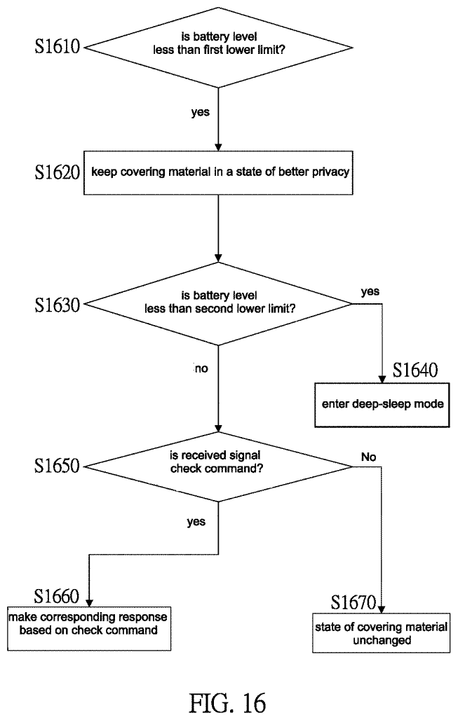

In order to remind the user to charge the battery in a timely manner to avoid battery wear and tear, and to ensure the user's privacy, in the embodiment shown in FIG. 16, the electric window covering 16 could perform the following control method:

Step S1610: for each of the electric window coverings 16, the power detection module 34 detects whether the battery level of the associated battery 32 is less than a first lower limit, which could be set as equal to or different from the power threshold mentioned above. The power detection module 34 could detect the battery level of the battery 32 in a periodical manner or after a specific event taking place (e.g., after receiving a command from the user).

Step S1620: for each of the electric window coverings 16, if the power detection module 34 finds out that the battery level of the associated battery 32 is less than the above-mentioned first lower limit, the associated control module 24 would demand the associated driving circuit 26 to control the associated driving module 22, whereby to drive the associated covering material 18, maintaining the associated covering material 18 in a state that provides better privacy, e.g., making the associated covering material 18 in fact or in effect completely closed.

Step S1630: for each of the electric window coverings 16, the power detection module 34 detects whether the battery level of the associated battery 32 is less than a second lower limit, which is less than the first lower limit mentioned above. Again, the power detection module 34 could detect the battery level of the battery 32 in a periodical manner or after a specific event.

Step S1640: for each of the electric window coverings 16, when the power detection module 34 finds out that the battery level of the associated battery 32 is less than the above-mentioned second lower limit, the battery level of the associated battery 32 has been very low, and therefore the associated control module 24 would demand the associated electric window covering 16 to go into a deep sleep mode. Once into the deep sleep mode, the control module 24 would cut off power for most of the components, or at least set them into a low power mode so that the power consumption of the associated electric window covering 16 would be significantly reduced, whereby to lower the power consumption of the associated battery 32. As a result, this could avoid causing the associated battery 32 malfunction due to a low battery level.

Step S1650: for each of the electric window coverings 16, when the wireless signal transceiver circuit 28 receives a signal, the associated control module 24 would determine whether the signal contains the check command mentioned above.

Step S1660: if the signal received by the wireless signal transceiver circuit 28 of one of the electric window coverings 16 contains the aforementioned check command, then the associated control module 24 would follow the embodiments mentioned above to demand the associated electric window covering 16 to make a corresponding response. Therefore, the battery level of the associated battery 32 would still be sufficient for the user to perform the battery level checking in order to know if the associated electric window covering 16 needs to be charged.

Step S1670: if the signal received by the wireless signal transceiver circuit 28 of one of the electric window coverings 16 does not contain the check command mentioned above, the state of the associated covering material 18 would not be changed. For example, if the received signal is a command sent by the user to move the position of the covering material 18 of one of the electric window coverings 16, the associated control module 24 would ignore this command in order to remind the user that the battery level of the associated battery 32 has been insufficient so that the user would notice there might be something wrong with the specified electric window covering 16. In addition, such design could also prevent the battery level of any of the batteries 32 from being overly exhausted and causing battery failure.

In the embodiment shown in FIG. 16, the first lower limit could be set as a value that, for any one of the electric window coverings 16, the battery level of the battery 32 thereof would be still sufficient to move the covering material 18 thereof to a state with greater privacy, also sufficient to use the wireless signal transceiver circuit 28 thereof to receive signals of a predetermined number of times for the control module 24 thereof to determine if the check command is contained therein, and sufficient for the electric window covering 16 to make corresponding responses as well. Besides, an additional battery level value could be further set according to the power consumption of the electric window coverings 16 over a period of time. Therefore, when the battery level of the battery 32 of any one of the electric window coverings 16 is less than the first lower limit, the battery level would still be sufficient to perform the control method shown in FIG. 16. On the other hand, the second lower limit could be set as a battery level value that is insufficient to perform most operations of the electric window coverings 16, but is still able to ensure that the batteries 32 are unlikely to wear and tear, whereby to prevent causing failures of the batteries 32. For example, the first lower limit and the second lower limit could be set according to a predetermined percentage of an actual capacity of the batteries 32, a predetermined voltage value, a predetermined current value, a predetermined internal resistance of the batteries 32, etc.

In the embodiment shown in FIG. 16, if the battery 32 is still not charged after taking Step S1660 or Step S1670, it would be appropriate to go back to Step S1630 to keep monitoring the battery level of the battery 32. In another embodiment, Step S1630 and Step S1640 could be omitted; only Steps S1610, S1620, S1650, S1660, and S1670 are included in the method.

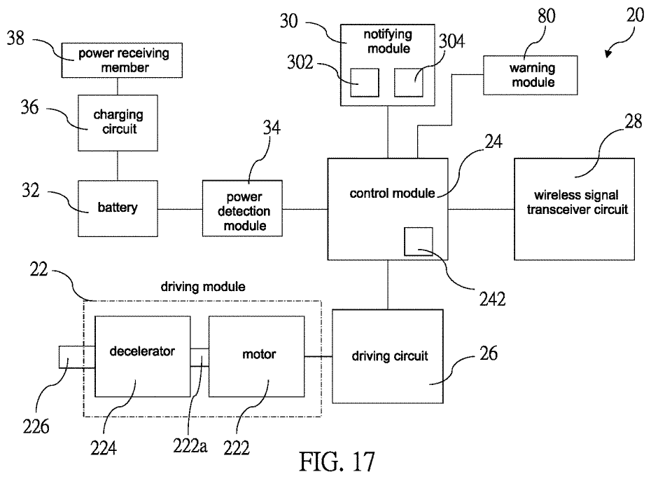

In Step S1640, a warning module 80, which consumes no electric power in the deep sleep mode, could be provided before the control module 24 enters the deep sleep mode, as shown in FIG. 17, so that the warning module 80 could provide a lower battery indication showing that the associated electric window covering 16 is in a state needing to be charged. Therefore, even if any one of the electric window coverings 16 is in the deep sleep mode and therefore most components thereof (e.g., the wireless signal transceiving circuit) are unable to operate, the user would still get to know that the electric window covering 16 needs to be charged without bothering to speculate why the electric window covering 16 is unable to operate. In another embodiment, each of the electric window coverings 16 includes a radio-frequency identification (RFID) tag used as the warning module 80. When the battery level of the battery 32 of anyone of the electric window coverings 16 is greater than the second lower limit, circuits related to the RFID tag thereof are in an open circuit status; when the battery level of the battery 32 of any one of the electric window coverings 16 is less than the second lower limit, circuits related to the RFID tag are in a short circuit status. The user could send out signals through the electronic device 10, the relay device 14, and/or other RFID reading devices. If the circuits related to the RFID tag of any one of the electric window coverings 16 are in the short circuit status, said circuits would then generate corresponding radio frequency signals, representing the situation that the referred electric window covering 16 runs out of battery and needs to be charged. In another embodiment, the electronic device 10, the relay device 14 and/or other signal reading devices would be able to send out specific wireless signals and read signals generated due to backscattering of the warning module 80 of any one of the electric window coverings 16. The control module 24 of each of the electric window coverings 16 could change the reflected signals by changing the impedance of the associated warning module 80. For instance, in one of the electric window coverings 16, when the control module 24 thereof arrange an antenna circuit (not shown) to be impedance matching, the antenna circuit would not backscatter the specific wireless signals mentioned above; when the control module 24 thereof enters the deep sleep mode, it would arrange the antenna circuit to be impedance mismatching, whereby the antenna circuit would backscatter the aforementioned specific wireless signals, so that the user would realize that the referred electric window covering 16 runs out of battery and needs to be charged. In the above embodiments, the warning modules 80 may be realized with the components which do not consume power from the battery of the electric window covering. For example, the RFID tags operate based on the received wireless signals, and the backscattering modules reflect wireless signals without consuming power from the battery of the electric window covering.

With the embodiments above, the batteries 32 of the electric window coverings 16 would not be depleted or malfunction due to exceedingly low battery level. Furthermore, when the battery level of the battery 32 of any one of the electric window coverings 16 is too low, the associated covering material 18 will be arranged into a status that maintains greater privacy, whereby to avoid disturbing the privacy of the user in case that the battery 32 is unable to provide sufficient power to move the covering material 18. In addition, by not changing the status of the covering material 18, the battery 32 would still have a moderate battery level to perform the battery level checking method described above. In this way, the user could be informed if any of the electric window coverings 16 has a lower battery level. More than that, the user could also learn about the status of the electric window coverings 16 through the battery level checking procedure, and would not even bother trying to figure out why the status of any of the electric window coverings 16 cannot be changed, whether it is because of running out of battery, poor communication, or malfunction mechanics. Whereby, the ease of use could be increased.

When the battery 32 is configured to situate in the bottom rail, the method in FIG. 16 may provide the advantage in monitoring the battery level of the battery 32 and charging the battery 32. For example, when the battery 32 is in the lower battery level, the bottom rail is lowered to make the covering material 18 to move to a substantially fully closed state. The user may easily charge or change the battery 32 in the lowered bottom rail.

According to the descriptions above, the method of controlling multiple electric window coverings provided in the present disclosure allows the user to actively initiate the battery level checking process of the electric window coverings through the electronic device when needed, whereby the electric window coverings 16 make different responses based on whether the battery levels of the batteries 32 is greater or less than the power threshold. In this way, the user could quickly learn about the status of the battery level of the battery 32 of each of the electric window coverings 16 by sight or sound, so the electric window coverings 16 with lower battery levels could be charged. In addition, the user could actively obtain the battery level information of all of the electric window coverings 16, and confirm the physical location in the surroundings of each of the electric window coverings 16.

It must be pointed out again that the embodiments described above are only some preferred embodiments of the present disclosure. All equivalent methods which employ the concepts disclosed in this specification and the appended claims should fall within the scope of the present disclosure.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of controlling multiple electric window coverings, wherein each of the electric window coverings comprises a covering material, a driving module, a battery, and a power detection module; the covering material is connected to the driving module to be driven to move by the driving module; the driving module comprises a motor; the battery provides power to the motor; the power detection module detects a battery level of the battery; the method comprising the steps of:
A. receiving a check command, which is created by an operated electronic device;
B. comparing the battery level of the battery of each of the electric window coverings to at least one power threshold; and
C. controlling the electric window coverings based on a comparison result obtained in the previous step in a manner that each of the electric window coverings which has its battery level of the battery thereof higher than the at least one power threshold makes a first response, and each of the electric window coverings which has its battery level of the battery thereof lower than the at least one power threshold makes a second response.

2. The method of claim 1, wherein, for each of the electric window coverings which makes the first response, the first response is to drive the covering material thereof to move to a first position by the driving module thereof; for each of the electric window coverings which makes the second response, the second response is to drive the covering material thereof to move to a second position by the driving module thereof; the second position is different from the first position.

3. The method of claim 2, wherein the covering material of each of the electric window coverings is more opened when at the first position than at the second position.

4. The method of claim 2, wherein, for each of the electric window coverings which makes the first response, how open the covering material is when moved to the first position is proportional to the battery level of the battery.

5. The method of claim 2, wherein, for each of the electric window coverings which makes the second response, how open the covering material is when moved to the second position is proportional to the battery level of the battery.

6. The method of claim 1, wherein each of the electric window coverings comprises a control module and a wireless signal transceiver circuit which are electrically connected to each other; the wireless signal transceiver circuit communicates with a relay device wirelessly, and the relay device communicates with the electronic device wirelessly;
wherein, step A comprises sending out the check command from the electronic device, and receiving the check command sent from the electronic device by the relay device; the relay device sends out a control command to the electric window coverings based on the check command;
wherein, in step B, after the wireless signal transceiver circuit of each of the electric window coverings receives the control command, the associated control module compares the battery level of the associated battery with the at least one power threshold;
wherein, in step C, each of the control modules controls the associated electric window covering to make the first response if the battery level of the associated battery is greater than the at least one power threshold, and controls the associated electric window covering to make the second response if the battery level of the associated battery is lower than the at least one power threshold.

7. The method of claim 6, further comprising transmitting the at least one power threshold from the electronic device to the control modules via the relay device prior to step B.

8. The method of claim 6, wherein, in step A, the control command sent out by the relay device contains the at least one power threshold; in step B, each of the control modules compares the battery level of the associated battery with the at least one power threshold contained in the control command.

9. The method of claim 1, wherein each of the electric window coverings comprises a control module and a wireless signal transceiver circuit which are electrically connected to each other; the wireless signal transceiver circuits communicate with a relay device wirelessly, and the relay device communicates with the electronic device wirelessly; the method further comprises a step prior to step A that each of the electric window coverings provides a battery level information, which regards the battery level of the associated battery detected by the associated power detection module, to the relay device through the associated wireless signal transceiver circuit;
wherein, step A further comprises sending out the check command by the electronic device, and receiving the check command transmitted from the electronic device by the relay device;
wherein, in step B, comparison between the battery level of the battery of each of the electric window coverings and the at least one power threshold is made by the relay device;
wherein, in step C, the relay device sends out a first control command at least to each of the electric window coverings which the battery level of the battery thereof is greater than the at least one power threshold; for each of the electric window coverings which the battery level of the battery thereof is greater than the at least one power threshold, after the wireless signal transceiver circuit thereof receives the first control command, the control module thereof controls the associated electric window covering to make the first response; the relay device sends out a second control command at least to each of the electric window coverings which the battery level of the battery thereof is less than the at least one power threshold; for each of the electric window coverings which the battery level of the battery thereof is less than the at least one power threshold, after the wireless signal transceiver circuit thereof receives the second control command, the control module thereof controls the associated electric window covering to make the second response.

10. The method of claim 9, further comprising a step of receiving the at least one power threshold from the electronic device.

11. The method of claim 9, wherein each of the control modules has a unique identifier; the first control command contains a first identifier, and the second control command contains a second identifier; in step C, after the wireless signal transceiver circuit of each of the electric window coverings receives the first control command or the second control command, the control module of each of the electric window coverings compares the unique identifier thereof with the first identifier or the second identifier; according to a comparison result obtained whereby, the control module of each of the electric window coverings controls the associated electric window covering to make the first response or the second response.

12. The method of claim 11, wherein each of the electric window coverings comprises a control module and a wireless signal transceiver circuit which are electrically connected to each other; the wireless signal transceiver circuits communicate with a relay device wirelessly, and the relay device communicates with the electronic device wirelessly; the method further comprises a step that each of the electric window coverings provides a battery level information, which regards the battery level of the associated battery detected by the associated power detection module, to the electronic device through the associated wireless signal transceiver circuit via the relay device.

13. The method of claim 12, wherein the battery level information of each of the electric window coverings is transmitted to the electronic device via the relay device prior to step A;
wherein, in step B, comparison between the battery level of the battery of each of the electric window coverings and the at least one power threshold is made by the electronic device;
wherein, in step C, the electronic device sends out a first control command to the relay device, and the relay device transmits the first control command at least to each of the electric window coverings which the battery level of the battery thereof is greater than the at least one power threshold; for each of the electric window coverings which the battery level of the battery thereof is greater than the at least one power threshold, after the wireless signal transceiver circuit thereof receives the first control command, the control module thereof controls the associated electric window covering to make the first response; the electronic device sends out a second control command to the relay device, and the relay device transmits the second control command at least to each of the electric window coverings which the battery level of the battery thereof is less than the at least one power threshold; for each of the electric window coverings which the battery level of the battery thereof is less than the at least one power threshold, after the wireless signal transceiver circuit thereof receives the second control command, the control module thereof controls the associated electric window covering to make the second response.

14. The method of claim 13, wherein each of the control modules has a unique identifier; the first control command contains a first identifier, and the second control command contains a second identifier; in step C, after the wireless signal transceiver circuit of each of the electric window coverings receives the first control command or the second control command, the control module of each of the electric window coverings compares the unique identifier thereof with the first identifier or the second identifier; according to a comparison result obtained whereby, the control module of each of the electric window coverings controls the associated electric window covering to make the first response or the second response.

15. The method of claim 12, wherein each of the control modules has a unique identifier; the method further comprises a step that, if not all of the electric window coverings have had the battery level information thereof transmitted to the electronic device, the electronic device sends out a compulsory battery check command to the relay device, wherein the compulsory battery check command contains a third identifier; the relay device forwards the compulsory battery check command; after the wireless signal transceiver circuit of each of the electric window coverings receives the compulsory battery check command, the control module of each of the electric window coverings compares the unique identifier thereof with the third identifier, wherein each of the electric window coverings having a matching comparison result transmits the battery level information thereof to the electronic device through the wireless signal transceiver circuit thereof via the relay device.

16. The method of claim 1, wherein, in step B, the at least one power threshold comprises more than one power threshold, and each of the power thresholds corresponds to one of the electric window coverings, respectively; in step C, each of the electric window coverings which the battery level of the battery thereof is greater than the corresponding power threshold makes the first response, while each of the electric window coverings which the battery level of the battery thereof is less than the corresponding power threshold makes the second response.

17. The method of claim 1, wherein each of the electric window coverings comprises a notifying module; the notifying module of each of the electric window coverings that makes the first response creates a first notifying state, whereby to make the first response; the notifying module of each of the electric window coverings that makes the second response creates a second notifying state, whereby to make the second response.

18. The method of claim 17, wherein each of the notifying modules comprises at least one light member; the first notifying state created by any of the notifying modules is that the at least one light member emits light of a first form; the second notifying state created by any of the notifying modules is that the at least one light member emits light of a second form.

19. The method of claim 17, wherein each of the notifying modules comprises at least one sound member; the first notifying state created by any of the notifying modules is that the at least one sound member makes a sound of a first form; the second notifying state created by any of the notifying modules is that the at least one sound member makes a sound of a second form.

20. The method of claim 1, wherein each of the electric window coverings comprises a control module and a wireless signal transceiver circuit which are electrically connected to each other; the control module has a unique identifier; the wireless signal transceiver circuits communicate with a relay device wirelessly, and the relay device communicate with the electronic device wirelessly; the method further comprises a step of sending a position-requesting command to the relay device by the electronic device, wherein the position-requesting command contains a position identifier; the relay device forwards the position-requesting command; after the wireless signal transceiver circuit of each of the electric window coverings receives the position-requesting command, the control module of each of the electric window coverings compares the unique identifier thereof with the position identifier, wherein each of the electric window covering having a matching comparison result makes a position-reporting response.

21. The method of claim 1, further comprising:
comparing a battery level of a battery of a first electric window covering to a first lower limit by utilizing a control module of the first electric window covering;
when the battery level of the battery of the first electric window covering is less than the first lower limit, moving a covering material of the first electric window covering to a substantially fully closed state by utilizing the motor.

22. The method of claim 21, further comprising:
receiving one or more wireless signals by utilizing a wireless signal transceiver circuit of each of the electric window coverings;
when the one or more wireless signals comprise the check command, comparing the battery level of the battery of each of the electric window coverings to the at least one power threshold and controlling each of the electric window coverings to make the first response or the second response based on the comparison result.

23. The method of claim 22, further comprising:
comparing the battery level of the battery of the first electric window covering to a second lower limit by utilizing the control module of the first electric window covering;
when the battery level of the battery of the first electric window covering is less than the second lower limit, controlling the battery of the first electric window covering to stop providing power to the wireless signal transceiver circuit of the first electric window covering and controlling a warning module, which requires no power consumption, to provide a low battery indication.
